(19) United States
(12) Patent Application Publication
(10) Pub. No.: US 2014/0096233 A1
(43) Pub. Date: Apr. 3, 2014

(54) SYSTEM AND METHOD FOR DISPLAY DEVICE ACCESS MANAGEMENT

(71) Applicant: Mersive Technologies, Inc., Denver, CO (US)

(72) Inventors: Christopher O. Jaynes, Denver, CO (US); Scott A. Ruff, Fort Collins, CO (US)

(73) Assignee: Mersive Technologies, Inc., Denver, CO (US)

(21) Appl. No.: 14/040,395

(22) Filed: Sep. 27, 2013

Related U.S. Application Data
(60) Provisional application No. 61/707,058, filed on Sep. 28, 2012.

(51) Int. Cl. G06F 21/31

(52) U.S. Cl. CPC G06F 21/31
USPC 726/16

(57) ABSTRACT

A system and method for display device access management. An alphanumeric key is generated and displayed on a display device. The key is entered into the system by a user within sight of the display device and authenticated by the system. Media sent to the display device by the user is then displayed on the display device.

### RELATED APPLICATIONS

This application claims priority to U.S. Provisional Patent Application No. 61/707,058 filed Sep. 28, 2012, incorporated herein by reference in its entirety.

### BACKGROUND

Computer displays are increasingly network capable and can support multiple users publishing to a particular display device remotely. Although this capability has its advantages, there is a need to lock a display device so that only local users can quickly access the display and preclude the use of the display by remote users.

### SUMMARY

A method is disclosed that locks the remote display capability of a particular display device and displays an access key on the display itself. In this way, users local to the display can use the visible key to gain access to the display device while display input from remote users remains locked.

Distinctions between the present approach and traditional ‘all or nothing’ passwords include:
Local users can learn the display key without having to request it.
The key is only shown to users who are within eyesight of the display and is not published over networks, or other means not associated with physical boundaries (i.e., users in a room next door cannot learn the password even if they are on the same wireless network).
Distant users who are in communication with local users, e.g., on a conference call, can still ask for the key from someone within eyesight of the physical display.
Display keys are associated intuitively with the display that they unlock.
More than one display can be locked with unique keys.
Display lock status is given by the presence or absence of the key shown on the display.

In operation, an alphanumeric key is generated and displayed on a display device. The key is entered into the system by a user within sight of the display device and authenticated by the system. Media sent to the display device by the user is then displayed on the display device. The present method allows users to quickly lock a display device to avoid unwanted media entering a session in which the display device is being shared among multiple users.

### BRIEF DESCRIPTION OF THE DRAWINGS

FIG. 1 is a diagram of an exemplary system configuration;

FIG. 2 is a flowchart showing an exemplary set of steps performed by the present method; and

FIG. 3 is a diagram of an exemplary system configuration in an alternative embodiment.

### DETAILED DESCRIPTION

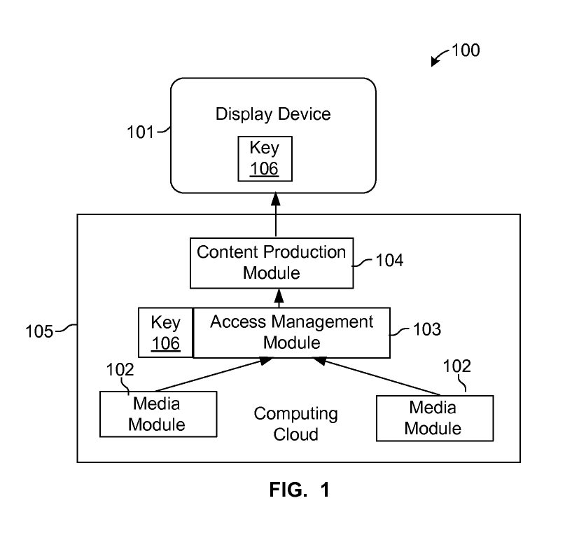

FIG. 1 shows an exemplary system configuration 100. The present system comprises software components that manage access to one or more physical display devices 101. These components comprise a content production module 104 that produces images and video to be displayed on the display(s), an access management module 103 that restricts access to the content production system via password control, and one or more media modules 102 that send images/video to the content production module 104. Components 101-104 are interconnected via networking means 105, which may comprise a computing cloud or other communication or networking mechanism.

In one embodiment, media modules 102 first negotiate for access to the display device 101 via communication with the access management module 103, as modules 102 are able to transmit images and video to a display only after successful authentication with access management module 103. Access management module 103 is a traditional password protection and authentication system that restricts users who do not have the proper password from gaining access to any of the display devices 101 in the system.

The present system creates a key 106 and authenticates users that are attempting to use a display device, based on their physical location, i.e., their being within viewing proximity of a display device 101 that is displaying a password or ‘key’. The present technique thus easily distinguishes between remote and physically present users during the access management module authentication phase, as only users that are within eyesight of the display device can (visually) determine the current key value.

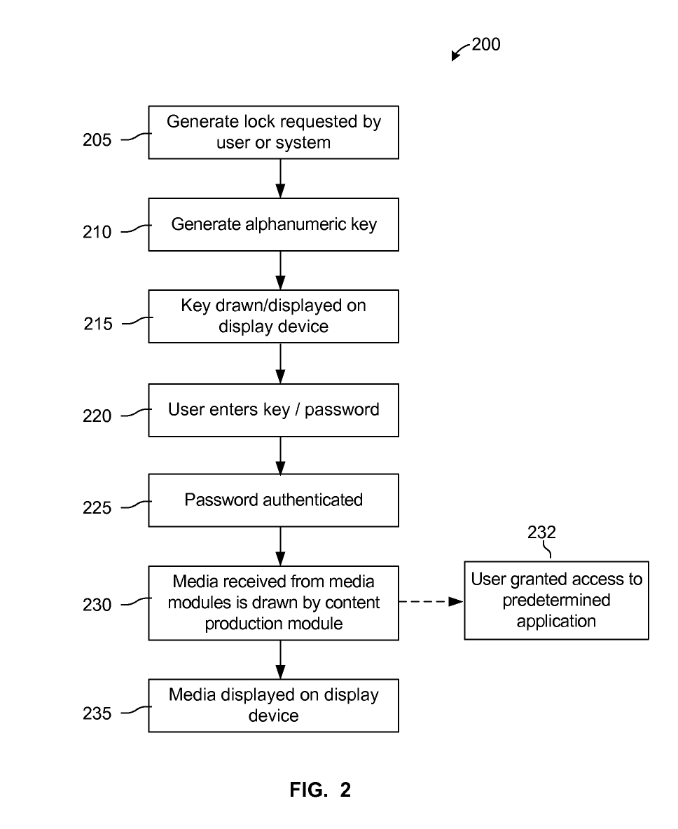

FIG. 2 is an exemplary flowchart showing an exemplary set of steps performed by the present method. As shown in FIG. 2, at step 205, first, a new lock is requested by a user, or created based on timed criteria or other settings. A lock can be requested by any media module 102 (software that will draw to the display) by communicating this request to the access management module 103. When a new lock is requested, the access management module 103 generates an alphanumeric key 106, representing the presently valid password, that is transmitted to the content production module for display on device 101, at step 210. The content production module 104 then draws the key to the display device 101, where the key is displayed, at step 215. Key 106 can be overlaid or otherwise comingled with other data being displayed at the same time. In this way, the key is associated with the physical display device and is provided in opentext form so that users who are able to see the display can learn the current key without additional communication between any system components.

Once a key 106 has been generated in this way, future requests by media modules to publish data to the display 101 require authentication via the password/key 106. Users within eyesight of the display simply read the key from the display to which they want to connect. When presented with a password query, the user, who is in visual communication with the display device (i.e., who can see the displayed key on the display), enters the visible alphanumeric key via a media module 102, at step 220, and, after authentication by access management module 103, is then able to send media (any form of displayable data) to that display. Once a user wants to open the display to remote viewers, the user requests the access management module 103 to remove the key. A key removal message is sent to the content production module(s) 104 and the key is removed visibly from the display.

Once authenticated (i.e., where the value of the key entered is the same as the value of the displayed key), at step 225, media transmitted into / received by the system from media modules 102 is drawn by the content production module 104 at step 230, and then displayed, at step 235, by the physical display device 101. For example, media modules 102 can be laptop computers on a network (represented by cloud 105). The access management module 103 and content production module 104 can be software running on a computer that is physically connected to the display device 101. In one embodiment, users must first type the password upon request from the access management module on the laptop computer 102. Once authenticated, the laptop 102 then sends data for display to the content production module 104 via the (now open) access management module 103. Content production module 104 then draws the data and displays it on display device 101. In one embodiment, as indicated by step 232, the user is granted access to a predetermined software application if the key is authenticated.

In an alternative embodiment, content production modules 104 can execute on the laptop computers 102 themselves, each of which is physically connected to the display 101. In this embodiment, the access management module 103 must first provide each laptop 102 with credentials for direct access to the display device.

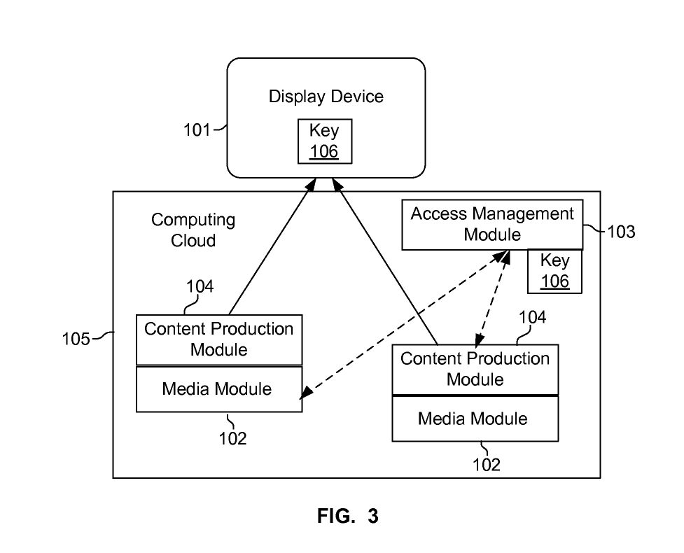

FIG. 3 is a diagram of an exemplary system configuration in an alternative embodiment. In the embodiment of FIG. 3, each media module 102 can render directly to the display 101 but cannot do so until credentials are provided by the access management module 103.

Certain changes may be made in the above methods and systems without departing from the scope of that which is described herein. It is to be noted that all matter contained in the above description or shown in the accompanying drawings is to be interpreted as illustrative and not in a limiting sense. The elements and steps shown in the present drawings may be modified in accordance with the methods described herein, and the steps shown therein may be sequenced in other configurations without departing from the spirit of the system thus described. The following claims are intended to cover all generic and specific features described herein, as well as all statements of the scope of the present method, system and structure, which, as a matter of language, might be said to fall therebetween.

What is claimed is:

1. A method for access management of a display device in a computing system comprising:
generating an alphanumeric key;
displaying the key on a display device;
receiving the key entered into the system by a user in visual communication with the display device on which the key is displayed;
authenticating the key if the value of the key entered is the same as the value of the displayed key;
sending media from the user to the display device; and
displaying the media on the display device if the key is authenticated.

2. A method for access management of a display device in a computing system comprising:
generating an alphanumeric key;
displaying the key on a display device;
receiving the key entered into the system by a user in visual communication with the display device on which the key is displayed;
authenticating the key if the value of the key entered is the same as the value of the displayed key; and
granting the user access to a software application if the key is authenticated.

3. The method of claim 2, including sending media from the user to the display device and, if the key is authenticated, displaying the media on the display device.

4. A method for access management of a display device in a computing system comprising:
displaying an alphanumeric key on a display device;
receiving the key which is entered into the system by a user who observes the key displayed on the display device;
authenticating the key if the value of the key entered is the same as the value of the displayed key; and
allowing media, sent from the user to the display device, to be displayed on the display device if the key is authenticated.
